(19) United States
(12) Patent Application Publication
(10) Pub. No.: US 2017/0079312 A1
(43) Pub. Date: Mar. 23, 2017

(54) METHOD OF PREPARING AND DISPLAYING TURKEY MEAT

(71) Applicants: Bill Salsburg, Fort Lauderdale, FL (US); Paul Salsburg, Fort Lauderdale, FL (US)

(72) Inventors: Bill Salsburg, Fort Lauderdale, FL (US); Paul Salsburg, Fort Lauderdale, FL (US)

(21) Appl. No.: 14/859,476

(22) Filed: Sep. 21, 2015

(51) Int. Cl. A23L 1/31; A23B 4/06; A22C 21/00

(52) U.S. Cl. CPC A23L 1/3155; A23L 1/0128; A23L 1/31463; A23B 4/068; A22C 21/0069; A22C 21/0092; A23V 2002/00

(57) ABSTRACT

A method of preparing, butchering, cooking, carving and plating a turkey for sale to consumers in a pre-cooked fashion. Either a whole turkey or individual turkey components including turkey breast, turkey thigh meat, drumstick, and wings are selected. The parts are cooked separately to assure complete cooking of each piece. After cooking, and while still hot, the tendons are removed from the drumstick to ease of consumption. The three sections of each wing are separated. Prior to cooking bone and skin is removed from the thighs and the resultant boneless meat is in inserted into a tubular cook-in casing cooked and eventually sliced. The turkey breasts are separated from the bone, soaked in a brine, cooked, and sliced. The cooked turkey components are placed in an oven-safe container in a pleasing and convenient arrangement with the thigh in the middle, flanked by the white meat, drumstick and wing components.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

1. Field of the Invention

The present invention generally relates to food preparation and packaging methods and more particularly to a method of preparing and displaying turkey meat.

2. Description of Related Art

In the United States, there are approximately 150 million chickens slaughtered for consumption per week as compared to approximately 4 million turkeys per week. The average American consumes chicken 2 to 3 times a week as compared to turkey, which is consumed only 2 to 3 times per year, typically in connection with major family holidays such as Thanksgiving. One reason for the lower consumption rates of whole turkey is the fact that a turkey is larger and more difficult to handle and, therefore, cooking, carving, and serving is much more difficult and time consuming in comparison to chicken. Moreover, a whole turkey yields a much greater quantity of edible meat compared to a chicken, often rendering the turkey unsuitable and uneconomical for consumption by a typical small family of 4-5 individuals. Recognizing the limitations of traditional methods of preparing, cooking, and serving whole turkey, the present invention is aimed at providing a heat-and-serve whole turkey prepared in a manner that results in an easy to ready and consume final product and that is displayed and contained in a functional and aesthetically pleasing manner. Additionally, the present invention allows for the turkey meat to be appropriately portioned for serving between 4 and 15 people, as desired, thereby eliminating food waste.

Several attempts have been made at providing methods and processes for preparing turkey and other meat for consumption, however none have adequately addressed all of the problems with the present state of the art. For example, U.S. Pat. Nos. 3,026,922 and 2,922,718 to Saverslak disclose a method of preparing a turkey where the meat and bones are removed from the skin. A binder and gluten is combined with the meat to form a processed combination turkey product. The meat is replaced into the skin and cooked to form a boneless final turkey product. The resultant product is an undesirable processed product. Similarly, U.S. Pat. No. 3,166,427 to Herrmann discloses a packaged poultry product where the breast and dark meat is removed from the bone, soaked in brine, placed in a mold under pressure and cooked. The cooked shaped product, which combines both white and dark meat, can be stored in either a freezer or a refrigerator. The shaped product, while more convenient, is far less appetizing than a natural product. U.S. Patent Application Publication No. 2011/0305806 to Ventimiglia discloses a method of making a boneless meat product from the mid joint wing portion of a bird wing. The wing tip and drumette are removed from the mid joint wing and then cooked. After cooking, the bones are removed, resulting in a boneless mid joint wing portion. While boneless wings may be desirable to some, there is significant flavor and texture loss that the present invention does not incur.

U.S. Pat. No. 2,008,313 to Gagliardi discloses and a method for deboning and combining thigh meat into a final product. The bone and other inedible material is removed from the thigh meat to provide a boneless thigh. The thin muscle is removed and the thick muscle is cut to form two equal sized thigh meat pieces. The thigh meat pieces are then cut along parallel lines to form elongated boneless thigh meat strips. This results in a processed thigh meat product that requires the thigh meat to be cut and sliced before forming, reducing flavor and texture. U.S. Pat. No. 5,273,483 to Gigliardi discloses another of preparing turkey thigh meat into a homogenous product for a more pleasing appearance. The method includes deboning the thigh meat and forming elongated pieces having a parallelogram cross-section.

U.S. Patent Publication No. 2014/0272008 to Wilson discloses a method for preparing and a final product comprising boneless thigh poultry meat. The method includes isolating a portion of thigh meat from the bone by cutting the inner side of the thigh along the longitudinal axis, detaching it from the bone, spreading it apart, and making additional cuts to remove all bone, cartilage, and sinew. The resultant product is a low fat-content thigh meat product that can be cooked and served as a standalone product. While the final form is natural and shapeless, the processing disturbs the integrity of the thigh meat, reducing flavor and texture.

U.S. Pat. No. 5,932,278 to Gagliardi discloses a method of cutting a boneless turkey breast into a plurality of turkey products that resemble steak products. U.S. Pat. No. 6,921,326 to Smith discloses a similar method of preparing turkey breast cutlets from a mold providing predetermined cutlet shapes. These processed shapes are generally not as appealing to consumers as more natural, flavorful products.

Other references disclose the arrangement and packaging of constituent meat components in a single, self-serve final product. For example, U.S. Pat. No. 6,579,549 and U.S. Patent Application Publication No. 2003/0203070 to Thrasher disclose the butchering, cooking, and chilling of meat product and then inserting the meat product into a pouch and serving tray along with a low pH sauce to preserve the meat for freezing, refrigeration, and/or serving. The required low pH sauce is an unwanted preservative that can greatly affect flavor and texture. U.S. Pat. No. 3,895,120 to Backus describes a method of preparing a dressed, raw fowl carcass to be baked in a pan. The carcass is severed lengthwise completely through the backbone region and then flattened by spreading apart. The carcass is placed upon a bed of stuffing in a pan with the carcass molded and shaped by the side wall of the pan whereby the wings and legs are positioned above the carcass breast portions. The pan is enclosed in a transparent envelope to provide a sales and/or baking package. While providing some advantage in packaging, the product is raw and still requires significant time and effort to properly cook and serve.

It is, therefore, to the effective resolution of the aforementioned problems and shortcomings of the prior art that the present invention is directed. However, in view of food preparation and packaging processes in existence at the time of the present invention, it was not obvious to those persons of ordinary skill in the pertinent art as to how the identified needs could be fulfilled in an advantageous manner.

### SUMMARY OF THE INVENTION

The present invention relates to a method of preparing, butchering, cooking, carving and plating a turkey for sale to consumers in a pre-cooked fashion. The method begins with either a whole turkey or individual turkey components including turkey breast, turkey thigh meat, drumstick, and wings. The parts are cooked separately to assure complete cooking of each piece. After cooking, and while still hot, the tendons are removed from the drumstick to ease of consumption. Prior to cooking, the three sections of each wing is separated. Additionally, prior to cooking bone and skin is removed from the thighs and the resultant boneless meat is in inserted into a tubular cook-in casing cooked and eventually cut into ¼ slices after cooling. The turkey breasts are separated from the bone, soaked in a brine, cooked, and cut into ¼ slices after they have cooled.

After all the pieces are cooked they are assembled in an oven safe container/tray. In some cases, the container is vacuum packed using a cook-in bag and then frozen. In other cases, the prepared turkey is sold refrigerated for immediate heating and serving. The final package includes sliced breast meat, sliced thigh meat from the tubular mold, drumstick and wing components laid out in an attractive platter. In some embodiments, the final arranged package includes the processed, sliced thigh meat at the center with the drumsticks on either side of the thigh meat. The sliced white meat is disposed in opposite corners of the tray, adjacent to the ends of the sliced thigh meat, on either side thereof. The three piece wings are disposed on the other opposite corners of the tray, along with the drumsticks.

### BRIEF DESCRIPTION OF THE DRAWINGS

FIG. 1A is an exemplary embodiment of a raw whole turkey and its components.

FIG. 1B is an exemplary embodiment of the separate components of a raw turkey.

FIG. 2 depicts raw turkey thigh meat being encased in a cook-in casing in accordance with the present method.

FIG. 3 demonstrates removal of tendons from a turkey drumstick.

FIG. 4 depicts one embodiment of the completed container and arrangement of turkey components in accordance with the present invention.

### DETAILED DESCRIPTION

The present invention is a method of manufacturing and process for preparing and displaying the edible and constituent parts of a turkey in a heat-and-serve fashion that is aesthetically pleasing, easy to prepare, and easy and enjoyable to consume. The present invention provides a method and process for preparing a turkey by carrying out all of the difficult parts of preparation that the end user typically does not want to do. As is described in detail herein, the present invention comprises a method and process of butchering, preparing, de-boning, seasoning, cooking, packaging and displaying a turkey for consumption. Through this process, the consumer is encouraged to increase turkey consumption as it is a quick, easy, and economical meal. Moreover, the final product obviates the need for consumers to purchase raw whole turkeys and cook them themselves, particularly in connection with hectic holidays or other large family gathering.

### Preparation

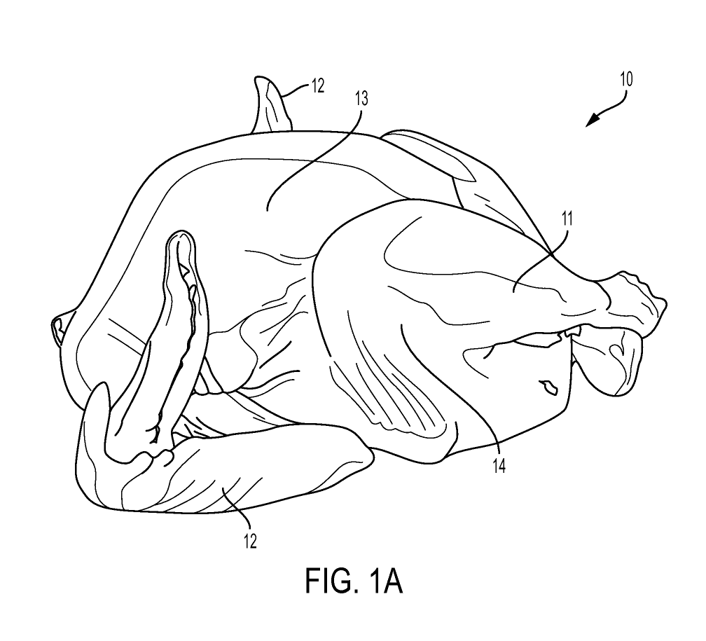

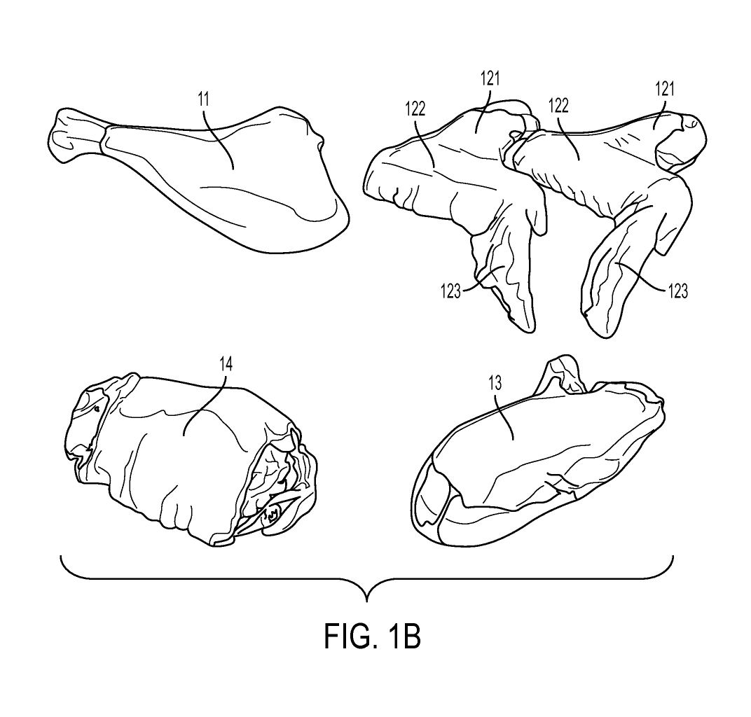

With reference to FIGS. 1A and 1B, the present invention includes a method and process that begins with either a whole turkey 10 or separately provided turkey parts including the drumstick 11, wings 12, breast meat 13, and thigh meat 14. Typically, a turkey in a weight range of 14-16 pounds is selected, although the weight can vary depending on the amount of final product desired. With a whole turkey, the parts are separated into smaller components. Specifically, the wings 12 are separated into three pieces to result in a drumette 121 and a wingette 122, with the wing tip 123 discarded. The breast meat 13, i.e. white meat, is de-skinned and de-boned. Alternatively, the skin on the breast meat 13 can be left intact for added flavor and texture. Thereafter, the breast meat 13 is brined by injecting brine or a marinade of choice into the boneless breast meat using a commercial food injector. The thigh meat 14, i.e. dark meat, is de-skinned and de-boned. In some embodiments, the thigh meat is processed to provide a uniform, sliceable product. Accordingly, with reference to FIG. 2, after the bone and skin is removed from the thigh meat 14, the aggregate thigh meat is inserted into a cook-in casing 15 to be later cooked, resulting in a natural but uniform thigh meat product. In some embodiments, the cook-in casing 15 provides a 3 inch diameter final product.

### Cooking

In some embodiments, the different turkey components, i.e. breast 13, thigh 14, drumsticks 101 and wing parts 121 and 122 are cooked separately due to the size of the components. This insures that all of the parts are cooked thoroughly to a food-safe internal temperature of 160 degrees Fahrenheit. In some embodiments, the turkey components are roasted in an oven at a temperature of approximately 300 degrees Fahrenheit. In other embodiments, a suitable roasting range of 250-450 degrees Fahrenheit may be used, although cooking temperatures at the extreme ends of this range may adversely affect taste and texture.

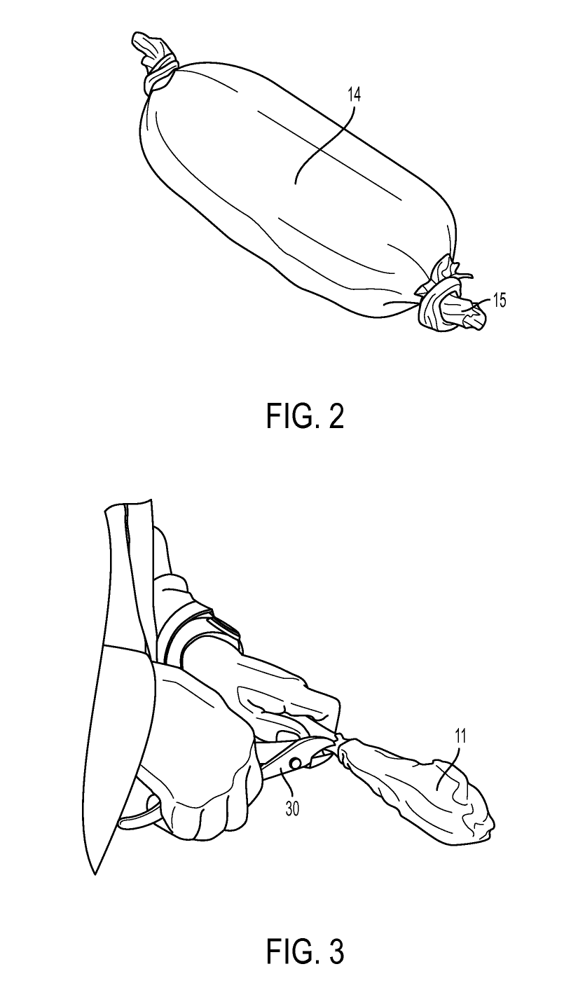

In some embodiments, with Reference to FIG. 3, after the drumsticks are cooked to an internal temperature of at least 160 degrees and still hot, tissue present at the base of the drumstick is removed, exposing the tendons running along the length of the drumstick. Then, a gripping device such as food-grade pliers 30 or a similar tool is used to pull the tendons lengthwise to remove them from the drumstick. This results in a final drumstick product that is far easier to consume than if the tendons were left intact. Following removal of the tendons, the cooked and prepared drumsticks 11 are moved to a chiller to be prepared for packaging. The separate wing components, namely the drumette 121 and wingette 122 are cooked together until they reach an internal temperature of 160 degrees. They are then removed and moved to a chiller to be prepared for packaging. The casing 15 containing the thigh meat 14 is also cooked to an internal temperature of at least 160 degrees. Once the encased thigh meat is cooked through, it is moved to the chiller for final preparation and packaging. After completion of the brining process discussed above, the turkey breast 13 is also cooked to an internal temperature of at least 160 degrees and then moved to a chiller for final preparation and packaging.

### Packaging and Display

The present method contemplates a unique packaged final product that further enhances the usability and desirability of the turkey meal. To that end, the final preparation, arrangement and packaging of the turkey meal is an important aspect of the present invention. Specifically, after the encased thigh meat 13 is thoroughly chilled, the casing 15 is removed and the thigh meat 14 is carved into slices. In some embodiments, the thigh meat 14 is carved into approximately ¼″ slices. This results in uniform, sliced but natural thigh meat product that is more enticing than the typical disorganized and formless thigh meat that results from traditional turkey carving. The breast 13 is also sliced as part of final preparation. In some embodiments, the breast 13 is sliced against the grain into approximately ¼″ slices.

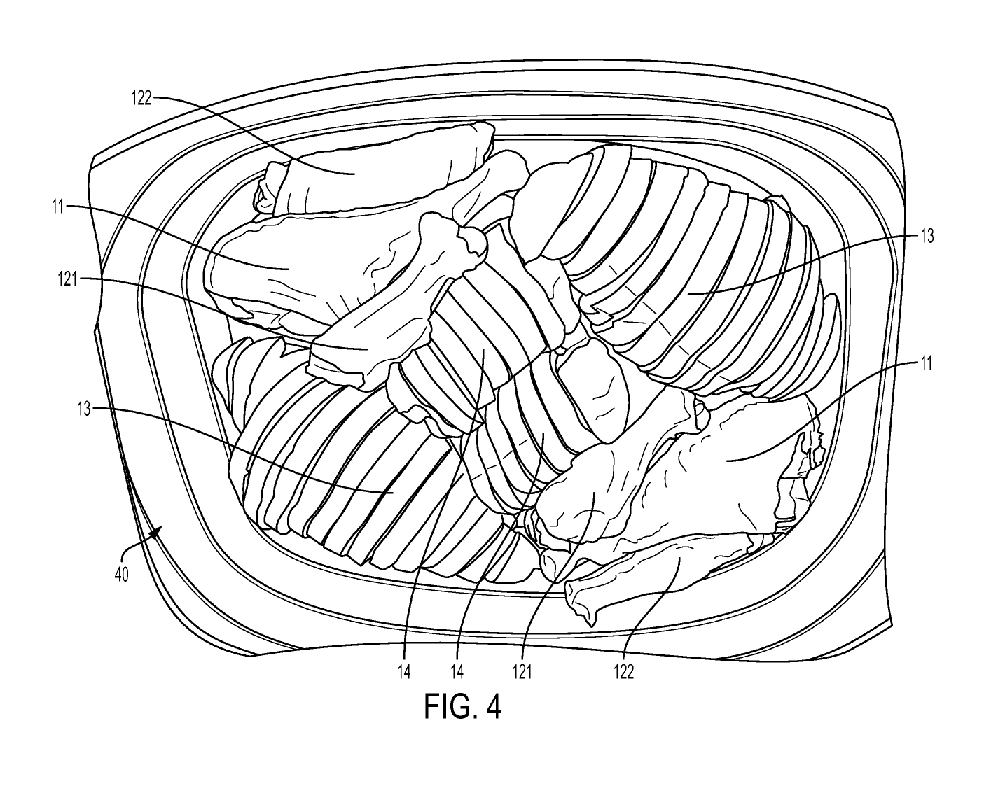

Following slicing of the thigh and breast meat, all of the individual components of the turkey are placed into an oven-safe tray/container in a specific arrangement selected for optimal use of space, aesthetics, and to allow the components to be properly and effectively re-heated for serving. Accordingly, with reference to FIG. 4, in some embodiments the components are arranged symmetrically in an oven-safe container 40, such as a foil pan. In some embodiments, the sliced thigh meat 14 is placed substantially at the center of the container, oriented diagonally. In some embodiments, the thigh meat 14 is provided in two rows substantially at the center of the container 40. The breast meat 13 is placed on either side of the ends of the thigh meat 14, such a portion of sliced breast meat 13 is located at opposite corners of the container 40. In some embodiments, the orientation of the slices of breast meat 13 is substantially perpendicular to the orientation of the slice of the thigh meat 13. The drumettes 121 are disposed on either side of the sliced thigh meat 14, oriented perpendicular to the direction of the slices. The drumsticks 11 are disposed on either side of the drumettes 121. In some embodiments, the drumsticks 11 and drumettes 121 are oriented parallel to one another. Finally, the wingettes 122 are disposed on either side of the drumsticks 11 and, in some embodiments, are oriented parallel thereto. Accordingly, the wingettes 122 are disposed at opposite corners from each other and in adjacent corners to the sliced breast meat 13.

To assure maximum retention of flavor and moisture after reheating, in some embodiments, liquid gravy or stock is added to the container. At this point the meal is ready for preservation for eventually re-heating and service. In some embodiments, the container 40 is vacuum packed using a cook-in vacuum bag and a conventional vacuum sealing device. After sealing, the completed container 40 is frozen for preservation. In other embodiments, the completed container 40 can be refrigerated if it is intended for immediate re-heating and consumption.

### Serving

The completed container 40 remains frozen or refrigerated until sold. At this point, the meal is ready for re-heating and services. In the case that the container 40 is froze, the meat is initially thawed out by leaving it in the refrigerator for at least 12 hours. Then, to reheat, an incision is made in the seal of the container. The entire container 40 is then placed in the oven or other cooking device and is reheated for 30 to 45 minutes at a temperature of 250-350 degrees, until the internal temperature reaches 130 degrees. Because the meal is cooked thoroughly prior to preservation, it is not necessary to raise the internal temperature to 160 degrees prior to services. To that end, needing only to heat the meat to 130 degrees, final preparation time is significantly less than cooking a raw whole turkey from scratch.

It is appreciated and understood that the present invention provides a process and final product of a turkey meal that is particularly convenient for the end customer. The process carries out all of the time consuming tasks that an individual seeks to avoid, i.e. preparing, butchering, cooking, and then professionally hand carving the turkey and then finally attractively arranging all of the parts into a pan suitable for heating and serving. This provides a substantial advantage over the traditional at-home process while also providing a superior product to ready-made turkeys presently available in stores, which are typically process and filler-based products that lack the flavor and texture of a traditionally prepared whole turkey. Accordingly, the present invention and final product has been developed with the consumer in mind, to provide a healthy natural meal together that is simple to prepare without the need for the consumer to spend the countless hours in the kitchen typically associated with preparing a roasted whole turkey.

It is appreciated and understood that several variations can be applied without departing from the sprit and scope of the present invention. For example, a variety of cooking styles can be applied beyond oven-roasting. Such styles including smoking or frying as is conventionally known, but with applying the process steps of preparation, butchering, encasing, slicing, packaging and displaying. Moreover, a variety of seasoning and marinades can be applied at the appropriate stage in the process, typically prior to cooking, to provide a final product with the desired taste profile.

While specific embodiments have been described in detail, those with ordinary skill in the art will appreciate that various modifications and alternatives to those details could be developed in light of the overall teachings of the disclosures. Accordingly, the particular arrangements disclosed are meant to be illustrative only and not limiting of the invention, which is to be given the full breadth of the appended claims, and any and all equivalents thereof.

What is claimed is:

1. A method of preparing and packing a turkey for consumption, comprising the steps of:
provisioning raw turkey components, including thigh meat, breast meat, one or more drumsticks, and one or more wings;
separating said one or more wings at least one joint to provide a wingette and a drumette;
de-boning said breast meat;
de-boning said thigh meat;
encasing said de-boned thigh meat in a cook-in casing;
cooking each of said drumsticks, said wingettes, said drumettes, said de-boned breast meat, and said encased de-boned thigh meat to an internal temperature of approximately 160 degrees Fahrenheit;
slicing said breast meat;
removing said casing from said thigh meat and slicing said thigh meat;
placing said cooked drumsticks, said wingettes, said drumettes, said sliced breast meat, and said sliced thigh meat into a container;
sealing said container; and
preserving said cooked drumsticks, said wingettes, said drumettes, said sliced breast meat, and said sliced thigh meat.

2. The method of preparing and packing a turkey for consumption in accordance with claim 1, further including the step of, after cooking said drumsticks, removing tissue at a base of said drumstick and removing one or more tendons from said drumstick.

3. The method of preparing and packing a turkey for consumption in accordance with claim 1, wherein prior to cooking, injecting said breast meat with a brine solution.

4. The method of preparing and packing a turkey for consumption in accordance with claim 1, wherein said step of preserving is accomplished by freezing.

5. The method of preparing and packing a turkey for consumption in accordance with claim 1, wherein said step of preserving is accomplished by refrigeration.

6. The method of preparing and packing a turkey for consumption in accordance with claim 1, wherein said sliced thigh meat is placed substantially at the center of the container, said breast meat is disposed on either side of ends of said thigh meat 14, such that a portion of said sliced breast meat is located at opposite corners of said container, said drumettes are disposed on either side of sides of said sliced thigh meat, said drumsticks are disposed on either side of said drumettes, and said wingettes are disposed on either side of said drumsticks.

7. A method of preparing a uniform turkey thigh meat product, comprising the steps of:
provisioning one or more pieces of said thigh meat;
de-boning said thigh meat;
de-skinning said thigh meat;
encasing said de-boned, de-skinned thigh meat into a cook-in casing; and
cooking said encased thigh meat to an internal temperature of approximately 160 degrees Fahrenheit.
